(19) United States
(12) Patent Application Publication
(10) Pub. No.: US 2021/0279021 A1
(43) Pub. Date: Sep. 9, 2021

(54) GROUPING SYSTEM, FIRST GROUPING APPARATUS, SECOND GROUPING APPARATUS, GROUPING MANAGEMENT APPARATUS, AND NON-TRANSITORY COMPUTER READABLE MEDIUM STORING GROUPING MANAGEMENT PROGRAM

(71) Applicant: FUJIFILM Business Innovation Corp., Tokyo (JP)

(72) Inventors: Takashi MORIMURA, Kanagawa (JP); Kenji MIYATA, Kanagawa (JP); Takuma SUZUKI, Kanagawa (JP)

(73) Assignee: FUJIFILM Business Innovation Corp., Tokyo (JP)

(21) Appl. No.: 16/920,742

(22) Filed: Jul. 5, 2020

(30) Foreign Application Priority Data
Mar. 6, 2020 (JP) 2020-039318

(51) Int. Cl. G06F 3/12

(52) U.S. Cl. CPC G06F 3/1262; G06F 3/1205

(57) ABSTRACT

A grouping system includes a first grouping apparatus having a first processor configured to receive a print order for a first apparatus, the print order including a plurality of jobs, group the plurality of jobs included in the print order for the first apparatus, specify ungrouped jobs that are jobs which are not grouped by the grouping, and perform a control to transmit the ungrouped jobs to a second grouping apparatus, and the second grouping apparatus having a second processor configured to receive a print order for a second apparatus, the print order including jobs, perform a control to receive the ungrouped jobs from the first grouping apparatus, and group the jobs included in the print order for the second apparatus and the ungrouped jobs.

### CROSS-REFERENCE TO RELATED APPLICATIONS

This application is based on and claims priority under 35 USC 119 from Japanese Patent Application No. 2020-039318 filed Mar. 6, 2020.

### BACKGROUND

### (i) Technical Field

The present invention relates to a grouping system, a first grouping apparatus, a second grouping apparatus, a grouping management apparatus, and a non-transitory computer readable medium storing a grouping management program.

### (ii) Related Art

For example, JP2007-272899A describes a method of managing a plurality of print jobs, which is executed by a print job management apparatus. This method includes receiving a plurality of print jobs, designating grouping conditions, grouping one or a plurality of print jobs into one or a plurality of groups according to designated grouping conditions without user operation; and transmitting grouping results.

Further, JP2000-057215A describes a factory integrated production planning system that plans production plans for a plurality of factories. This factory integrated production planning system includes an allocation unit that first allocates production of ordered items to an available production machine at a factory closest to a destination, based on order data and destination data, a calculation unit that calculates ordered items which are not in time for delivery, among the allocated ordered items, and a reallocation unit that reallocates the ordered items that are not in time for delivery such that cost is minimized.

### SUMMARY

For example, in production sites such as companies, factories, and offices, jobs with an identical attribute are grouped and processed efficiently. However, grouping is performed only in each production site, and in a case where jobs with an identical attribute are not collected, grouping may not be possible and efficient processing may be difficult.

Aspects of non-limiting embodiments of the present disclosure relate to a grouping system, a first grouping apparatus, a second grouping apparatus, a grouping management apparatus, and a non-transitory computer readable medium storing a grouping management program, that are capable of grouping jobs that cannot be grouped at each production site, among a plurality of production sites.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided a grouping system including a first grouping apparatus having a first processor configured to receive a print order for a first apparatus, the print order including a plurality of jobs, group the plurality of jobs included in the print order for the first apparatus, specify ungrouped jobs that are jobs which are not grouped by the grouping, and perform a control to transmit the ungrouped jobs to a second grouping apparatus; and the second grouping apparatus having a second processor configured to receive a print order for a second apparatus, the print order including jobs, perform a control to receive the ungrouped jobs from the first grouping apparatus, and group the jobs included in the print order for the second apparatus and the ungrouped jobs.

### BRIEF DESCRIPTION OF THE DRAWINGS

Exemplary embodiment(s) of the present invention will be described in detail based on the following figures, wherein:

FIG. 1 is a diagram illustrating an example of a configuration of a grouping system according to a first exemplary embodiment;

FIG. 2 is a block diagram illustrating an example of electrical configurations of a first grouping apparatus and a second grouping apparatus according to the first exemplary embodiment;

FIG. 3 is a block diagram illustrating an example of functional configurations of the first grouping apparatus and the second grouping apparatus according to the first exemplary embodiment;

FIG. 4 is a flowchart illustrating an example of a processing flow by a first grouping processing program according to the first exemplary embodiment;

FIG. 5 is a diagram illustrating an example of an ordered job list and a production schedule of each production site according to the exemplary embodiment;

FIG. 6 is a diagram for explaining a grouping availability determination process for ungrouped jobs according to the exemplary embodiment;

FIG. 7A is a front view illustrating an example of an ordering screen according to the exemplary embodiment; FIG. 7B is a front view illustrating an example of an order-receiving screen according to the exemplary embodiment;

FIG. 8 is a flowchart illustrating an example of a processing flow by a second grouping processing program according to the first exemplary embodiment;

FIG. 9 is a diagram illustrating an example of a configuration of a grouping system according to a second exemplary embodiment;

FIG. 10 is a block diagram illustrating an example of an electrical configuration of a grouping management apparatus according to the second exemplary embodiment;

FIG. 11 is a block diagram illustrating an example of a functional configuration of the grouping management apparatus according to the second exemplary embodiment; and

FIG. 12 is a flowchart illustrating an example of a processing flow by a grouping management program according to the second exemplary embodiment.

### DETAILED DESCRIPTION

Hereinafter, an example of exemplary embodiments for carrying out the present invention will be described in detail with reference to the drawings.

### First Exemplary Embodiment

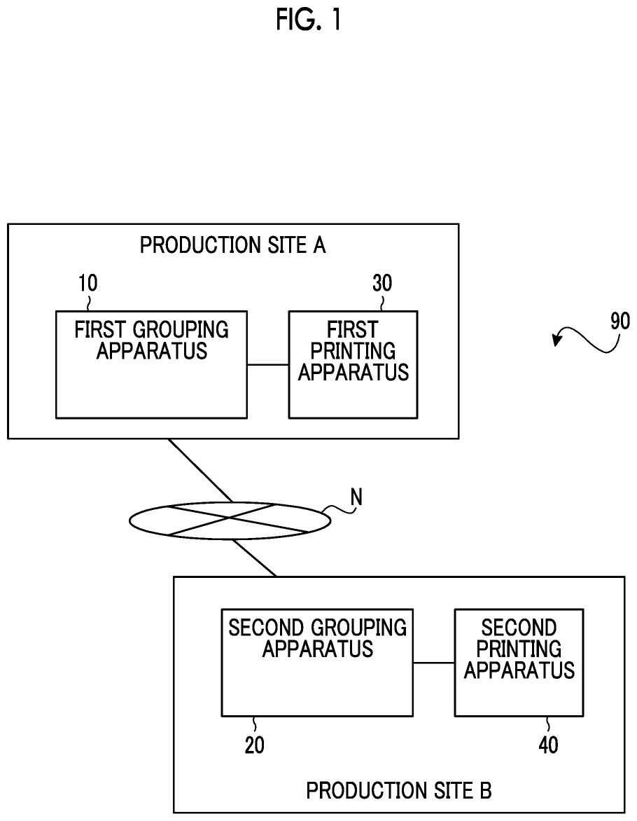

FIG. 1 is a diagram illustrating an example of the configuration of a grouping system 90 according to a first exemplary embodiment.

As illustrated in FIG. 1, the grouping system 90 according to the present exemplary embodiment includes a first grouping apparatus 10 and a second grouping apparatus 20. The first grouping apparatus 10 is communicatively connected to a first printing apparatus 30, and the first grouping apparatus 10 and the first printing apparatus 30 are installed at a production site A. The second grouping apparatus 20 is communicatively connected to a second printing apparatus 40, and the second grouping apparatus 20 and the second printing apparatus 40 are installed in a production site B.

The production site A and the production site B are, for example, production sites of companies, factories, offices, or the like, and in the present exemplary embodiment, are sites for producing various printed materials such as books and magazines. The number of production sites is not limited to two, and may be three or more.

The first grouping apparatus 10 is communicatively connected to the second grouping apparatus 20 via a network N. The network N is, for example, the Internet, a local area network (LAN) , a wide area network (WAN), or the like. As the first grouping apparatus 10, for example, a general-purpose computer apparatus such as a server computer or a personal computer (PC) is applied. The first grouping apparatus 10 has a function of managing a plurality of jobs processed by the first printing apparatus 30, grouping the plurality of jobs, and creating a processing schedule of the plurality of jobs. The first printing apparatus 30 is an example of the first apparatus. Further, the job here represents a print processing unit. For example, one job represents print data in a case of printing one file.

Similar to the first grouping apparatus 10, as the second grouping apparatus 20, for example, a general-purpose computer apparatus such as a server computer or a personal computer (PC) is applied. The second grouping apparatus 20 has a function of managing a plurality of jobs processed by the second printing apparatus 40 and grouping the plurality of jobs, and a function of creating a processing schedule of the plurality of jobs. The second printing apparatus 40 is an example of the second apparatus.

In addition to the first grouping apparatus 10 and the first printing apparatus 30, for example, a processing apparatus, a post-processing apparatus, a cutting apparatus, and the like may be installed in the production site A. Similarly, in addition to the second grouping apparatus 20 and the second printing apparatus 40, for example, a processing apparatus, a post-processing apparatus, a cutting apparatus, and the like may be installed in the production site B.

The processing apparatus is, for example, an apparatus that performs processes such as coating varnish to suppress scratches and stains from adhering to the printed side of a recording medium (hereinafter referred to as “sheet”) such as paper on which data is printed by the first printing apparatus 30 or the second printing apparatus 40. The post-processing apparatus is, for example, an apparatus that performs processes such as binding sheets of text in a state of being folded so as to be arranged in page order, attaching a cover, and forming a booklet. The cutting apparatus is, for example, an apparatus that performs processes such as cutting a margin portion of a bound booklet and finishing the booklet in a predetermined size.

The grouping system 90 according to the present exemplary embodiment manages a plurality of jobs ordered at each production site, a production schedule of the plurality of jobs, and the like. With respect to the jobs overflowing from the job group in which a plurality of jobs are grouped for efficient production at a certain production site, the grouping system 90 enables grouping of jobs at another production site.

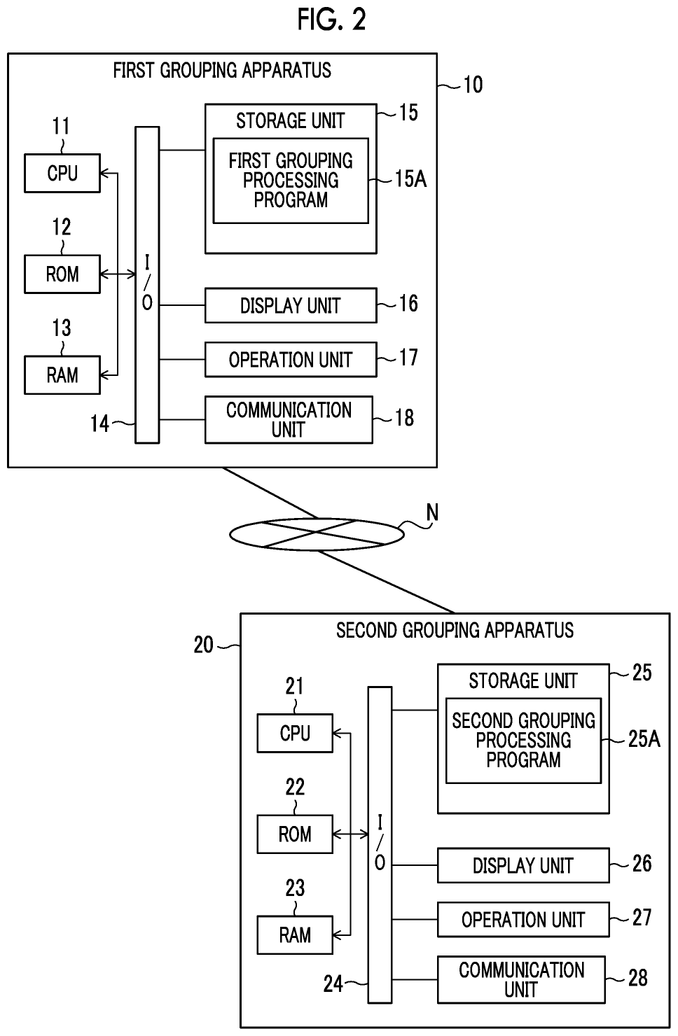

FIG. 2 is a block diagram illustrating an example of electrical configurations of the first grouping apparatus 10 and the second grouping apparatus 20 according to the first exemplary embodiment.

As illustrated in FIG. 2, the first grouping apparatus 10 according to the present exemplary embodiment includes a central processing unit (CPU) 11, a read only memory (ROM) 12, a random access memory (RAM) 13, and an input/output interface (I/O) 14, a storage unit 15, a display unit 16, an operation unit 17, and a communication unit 18.

The CPU 11, the ROM 12, the RAM 13, and the I/O 14 are connected to each other via a bus. Functional units including the storage unit 15, the display unit 16, the operation unit 17, and the communication unit 18 are connected to the I/O 14. Each of the functional units can communicate with the CPU 11 via the I/O 14.

A control unit is configured with the CPU 11, the ROM 12, the RAM 13, and the I/O 14. The control unit may be configured as a sub-control unit that controls a part of the operation of the first grouping apparatus 10, or may be configured as a part of a main control unit that controls the entire operation of the first grouping apparatus 10. For example, an integrated circuit such as a large scale integration (LSI) or an integrated circuit (IC) chip set is used for a part or all of each block of the control unit. For each of the above blocks, an individual circuit may be used or a circuit in which some or all are integrated may be used. The above blocks may be provided integrally with each other, or some blocks maybe provided separately. In addition, apart of each of the blocks may be provided separately. For the integration of the control unit, not only the LSI but also a dedicated circuit or a general-purpose processor may be used.

As the storage unit 15, for example, a hard disk drive (HDD), a solid state drive (SSD), a flash memory, or the like is used. The storage unit 15 stores a first grouping processing program 15A according to the present exemplary embodiment. The first grouping processing program 15A may be stored in the ROM 12.

The first grouping processing program 15A may be installed in advance in the first grouping apparatus 10, for example. The first grouping processing program 15A may be realized by being stored in a non-volatile storage medium or distributed via the network N and appropriately installed in the first grouping apparatus 10. As an example of the non-volatile storage medium, a compact disc read only memory (CD-ROM), a magneto-optical disk, an HDD, a digital versatile disc read only memory (DVD-ROM) , a flash memory, a memory card, or the like is assumed.

For the display unit 16, for example, a liquid crystal display (LCD) , an organic electro luminescence (EL) display, or the like is used. The display unit 16 may integrally have a touch panel. The operation unit 17 is provided with a device for operation input such as a keyboard and a mouse. The display unit 16 and the operation unit 17 receive various instructions from the user of the first grouping apparatus 10. The display unit 16 displays various types of information such as a result of a process executed in response to an instruction received from the user and a notification for a process.

The communication unit 18 is connected to the network N such as the Internet, LAN, and WAN, and can communicate with the second grouping apparatus 20 via the network N.

The second grouping apparatus 20 according to present exemplary embodiment includes a CPU 21, a ROM 22, a RAM 23, an I/O 24, a storage unit 25, a display unit 26, an operation unit 27, and a communication unit 28.

The CPU 21, the ROM 22, the RAM 23, and the I/O 24 are connected to each other via a bus. Functional units including the storage unit 25, the display unit 26, the operation unit 27, and the communication unit 28 are connected to the I/O 24. Each of the functional units can communicate with the CPU 21 via the I/O 24.

A control unit is configured with the CPU 21, the ROM 22, the RAM 23, and the I/O 24. The control unit may be configured as a sub-control unit that controls a part of the operation of the second grouping apparatus 20, or may be configured as a part of a main control unit that controls the entire operation of the second grouping apparatus 20.

As the storage unit 25, for example, an HDD, an SSD, a flash memory or the like is used. The storage unit 25 stores a second grouping processing program 25A according to the present exemplary embodiment. The second grouping processing program 25A may be stored in the ROM 22.

The second grouping processing program 25A may be installed in advance in the second grouping apparatus 20, for example. The second grouping processing program 25A may be realized by being stored in a non-volatile storage medium or distributed via the network N and appropriately installed in the second grouping apparatus 20. The second grouping processing program 25A is a program that operates in cooperation with the first grouping processing program 15A.

For the display unit 26, for example, a liquid crystal display (LCD) , an organic EL display or the like is used. The display unit 26 may integrally have a touch panel. The operation unit 27 is provided with a device for operation input such as a keyboard and a mouse. The display unit 26 and the operation unit 27 receive various instructions from the user of the second grouping apparatus 20. The display unit 26 displays various types of information such as a result of a process executed in response to an instruction received from the user and a notification for a process.

The communication unit 28 is connected to a network N such as the Internet, LAN, and WAN, and can communicate with the first grouping apparatus 10 via the network N.

Incidentally, as described above, at each production site, jobs having with an identical attribute are grouped and efficiently processed. However, grouping is performed only in each production site, and in a case where jobs with an identical attribute are not collected, grouping may not be possible and efficient processing may be difficult.

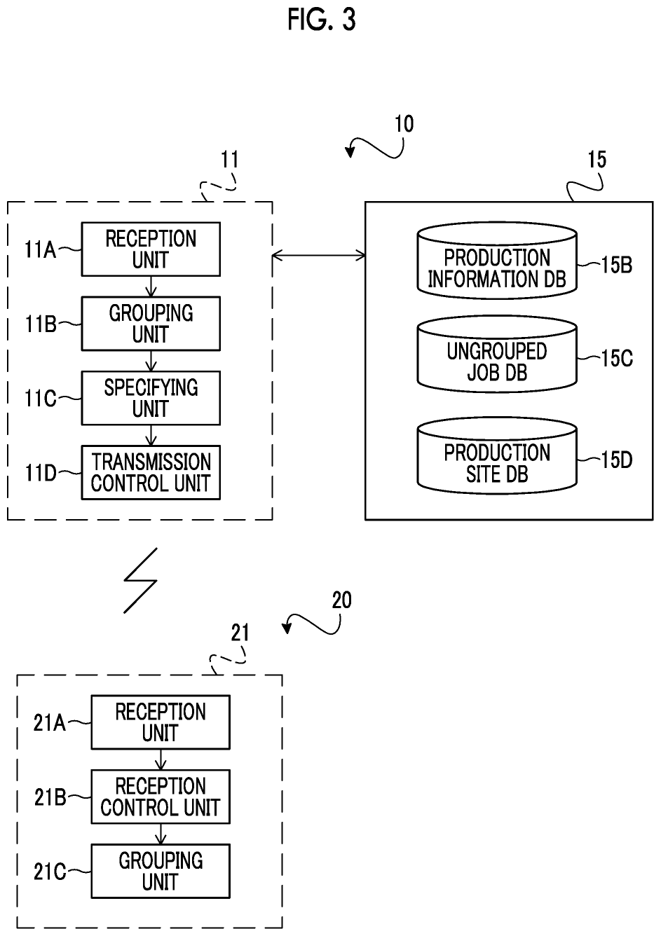

Therefore, the CPU 11 of the first grouping apparatus 10 according to the present exemplary embodiment functions as each unit illustrated in FIG. 3 by writing the first grouping processing program 15A stored in the storage unit 15 into the RAM 13 and executing the program 15A. The CPU 11 is an example of a first processor. Further, the CPU 21 of the second grouping apparatus 20 according to the present exemplary embodiment functions as each unit illustrated in FIG. 3 by writing the second grouping processing program 25A stored in the storage unit 25 into the RAM 23 and executing the program 25A. The CPU 21 is an example of a second processor.

FIG. 3 is a block diagram illustrating an example of functional configurations of the first grouping apparatus 10 and the second grouping apparatus 20 according to the first exemplary embodiment.

As illustrated in FIG. 3, the CPU 11 of the first grouping apparatus 10 according to the present exemplary embodiment functions as a reception unit 11A, a grouping unit 11B, a specifying unit 11C, and a transmission control unit 11D. Further, the CPU 21 of the second grouping apparatus 20 according to the present exemplary embodiment functions as a reception unit 21A, a reception control unit 21B, and a grouping unit 21C.

In the storage unit 15 of the first grouping apparatus 10 according to the present exemplary embodiment, a production information database (hereinafter, referred to as “production information DB”) 15B, an ungrouped job database (hereinafter, referred to as “ungrouped job DB”) 15C, and a production site database (hereinafter, referred to as “production site DB”) 15D are stored. The production information DB 15B, the ungrouped job DB 15C, and the production site DB 15D may be stored in an external server apparatus or the like.

In the production information DB 15B, jobs that have been ordered for each production site constituting the grouping system 90 and a production schedule for processing jobs that have been ordered for each production site are registered. Further, jobs that could not be grouped at each production site (hereinafter referred to as “ungrouped jobs”) are registered in the ungrouped job DB 15C. In addition, each production site constituting the grouping system 90 is registered in the production site DB 15D. That is, in the production site DB 15D, the production sites at which ungrouped jobs are grouped are registered in advance. In the production information DB 15B, the production schedules of the production sites registered in the production site DB 15D are centrally managed.

The reception unit 11A according to the present exemplary embodiment receives a print order for the first printing apparatus 30. This print order includes a plurality of jobs. The reception unit 11A registers each of the plurality of jobs included in the print order in association with the attribute in the production information DB 15B. Examples of the job attributes include the number of copies to be printed (the number of printing sheets) , the type of paper, the size of paper, the post-processing content, and the like.

The grouping unit 11B according to the present exemplary embodiment groups a plurality of jobs included in a print order for the first printing apparatus 30. This grouping is performed based on a predetermined condition such as matching of at least one of the job attributes. The grouping unit 11B registers the grouping results of a plurality of jobs in the production information DB 15B.

The specifying unit 11C according to the present exemplary embodiment specifies ungrouped jobs which are not grouped by the grouping performed by the grouping unit 11B. Specifically, the specifying unit 11C specifies, among a plurality of jobs, jobs of which attributes do not match, as ungrouped jobs. The specifying unit 11C registers the job specified as the ungrouped job in the ungrouped job DB 15C. Further, the specifying unit 11C may register the ungrouped job and the amount of money for the ungrouped job in association with each other in the ungrouped job DB 15C. The amount of money for the ungrouped job is represented as, for example, the ordered amount of money when the print order for the job is received.

The transmission control unit 11D according to the present exemplary embodiment performs control to transmit the ungrouped job specified by the specifying unit 11C to the second grouping apparatus 20.

Here, in a case where there is no change in the job processing schedule for the second printing apparatus 40 due to grouping of the ungrouped jobs by the second grouping apparatus 20, the transmission control unit 11D may perform a control to transmit the ungrouped jobs to the second grouping apparatus 20. Whether or not a change occurs in the job processing schedule for the second printing apparatus 40 is determined, for example, by referring to the production schedule of the production site B registered in the production information DB 15B.

Further, in a case where there is a change in the job processing schedule for the second printing apparatus 40 due to grouping of the ungrouped jobs by the second grouping apparatus 20, the transmission control unit 11D may perform control not to transmit the ungrouped jobs to the second grouping apparatus 20.

Further, in a case where there is a change in the job processing schedule for the second printing apparatus 40 due to grouping of the ungrouped jobs by the second grouping apparatus 20, the transmission control unit 11D may inquire whether or not to transmit the ungrouped jobs to the second grouping apparatus 20. In a case where there is a response from the second grouping apparatus 20 that the ungrouped job is received, the ungrouped job is transmitted. In a case where there is a response from the second grouping apparatus 20 that the ungrouped job is not received, the ungrouped job is not transmitted.

Further, in a case where the ungrouped jobs are not transmitted to the second grouping apparatus 20, the grouping unit 11B may set a deadline for grouping the ungrouped jobs before the delivery deadline of the ungrouped jobs. Specifically, in a case where grouping ungrouped jobs is retried, the next grouping needs to be performed before the delivery deadline of the ungrouped jobs. Therefore, it is preferable to set, for example, a deadline for grouping before the delivery deadline of an ungrouped job.

On the other hand, the reception unit 21A according to the present exemplary embodiment receives a print order for the second printing apparatus 40. The print order includes one or more jobs. The reception unit 21A registers each of the plurality of jobs included in the print order with the production information DB 15B in association with the attribute thereof. At this time, the grouping unit 21C groups a plurality of jobs included in the print order for the second printing apparatus 40. The grouping unit 21C registers the grouping results of a plurality of jobs in the production information DB 15B.

The reception control unit 21B according to the present exemplary embodiment performs control to receive an ungrouped job from the first grouping apparatus 10.

The grouping unit 21C according to the present exemplary embodiment groups a plurality of jobs included in a print order for the second printing apparatus 40 and an ungrouped job received from the first grouping apparatus 10.

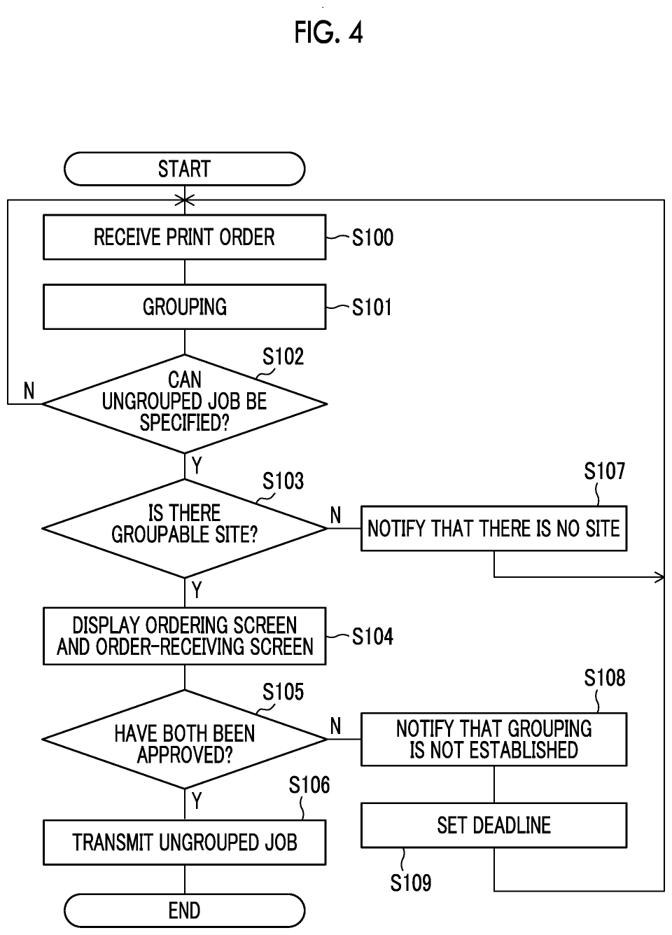

Next, the operation of the first grouping apparatus 10 according to the first exemplary embodiment will be described with reference to FIG. 4.

FIG. 4 is a flowchart illustrating an example of the processing flow by the first grouping processing program 15A according to the first exemplary embodiment.

First, in a case where the user instructs the first grouping apparatus 10 to start the grouping process, the first grouping processing program 15A is activated to execute the following steps.

In step S100 of FIG. 4, the CPU 11 receives a print order for the first printing apparatus 30.

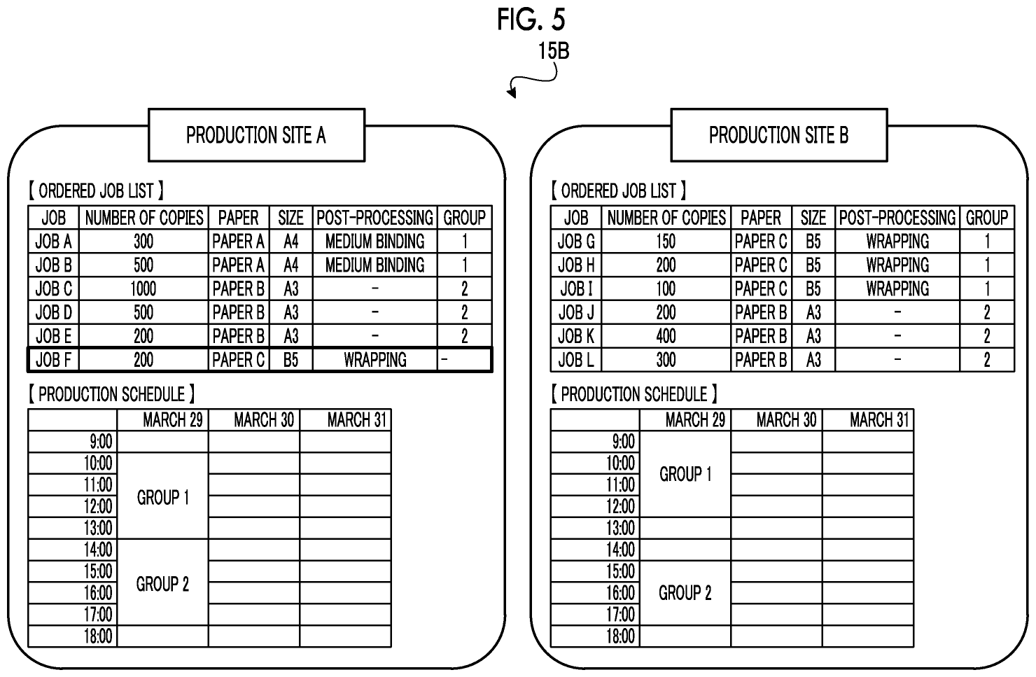

In step S101, the CPU 11 groups a plurality of jobs included in the print order received in step S100. Here, an example of the ordered job list and the production schedule of each of the production site A and the production site B is illustrated in FIG. 5.

FIG. 5 is a diagram illustrating an example of an ordered job list and a production schedule of each production site according to the present exemplary embodiment.

The ordered job list and the production schedule of the production site A illustrated in FIG. 5 are registered in the production information DB 15B. Further, the ordered job list and the production schedule of the production site B are acquired from the second grouping apparatus 20 and registered in the production information DB 15B.

In the example of FIG. 5, a plurality of jobs A to F are ordered at the production site A, and attributes of the jobs A to F are registered. As described above, the job attributes include the number of copies to be printed, the type of paper, the size of paper, and the post-processing contents. Although not illustrated in the example of FIG. 5, the ordered amount of money of each of the jobs A to F may be included. In the example of FIG. 5, job A and job B are grouped into a group 1. This is because the types of papers, the sizes of papers, and the post-processing contents are identical in jobs A and B. Further, jobs C to E are grouped into a group 2. This is because the types of papers, the sizes of papers, and the post-processing contents are the identical in jobs C to E. Here, the attributes of the job F do not match the attributes of the job of the group 1 and the attributes of the job of the group 2. Therefore, the job F is an ungrouped job that cannot be grouped. Further, in the example of FIG. 5, production schedules are set up for the group 1 of job A and job B at 10:00 to 14:00 on March 29, and the group 2 of job C to job E at 14:00 to 18:00 on March 29, respectively.

Similarly, a plurality of jobs G to L are ordered at the production site B, and attributes of the jobs G to L are registered. In the example of FIG. 5, jobs G to I are grouped into the group 1. This is because the types of papers, the sizes of papers, and the post-processing contents are the identical in jobs G to I. Further, jobs J to L are grouped into the group 2. This is because the types of papers, the sizes of papers, and the post-processing contents are the identical in jobs J to L. Further, in the example of FIG. 5, production schedules are set up for the group 1 of job G to job I at 9:00 to 13:00 on March 29, and the group 2 of job J to job L at 15:00 to 18:00 on March 29, respectively.

In step S102, the CPU 11 refers to, for example, the production information DB 15B, specifically, the ordered job list of the production site A illustrated in FIG. 5 described above, and determines whether or not the ungrouped job can be specified. In a case where it is determined that the ungrouped job can be specified (in the case of positive determination), the process proceeds to step S103, and in a case where it is determined that the ungrouped job cannot be specified (in the case of negative determination), the process returns to step S100 to wait until the next grouping. In the example of FIG. 5 described above, the job F is specified as an ungrouped job. In this case, the CPU 11 registers the job F specified as the ungrouped job in the ungrouped job DB 15C.

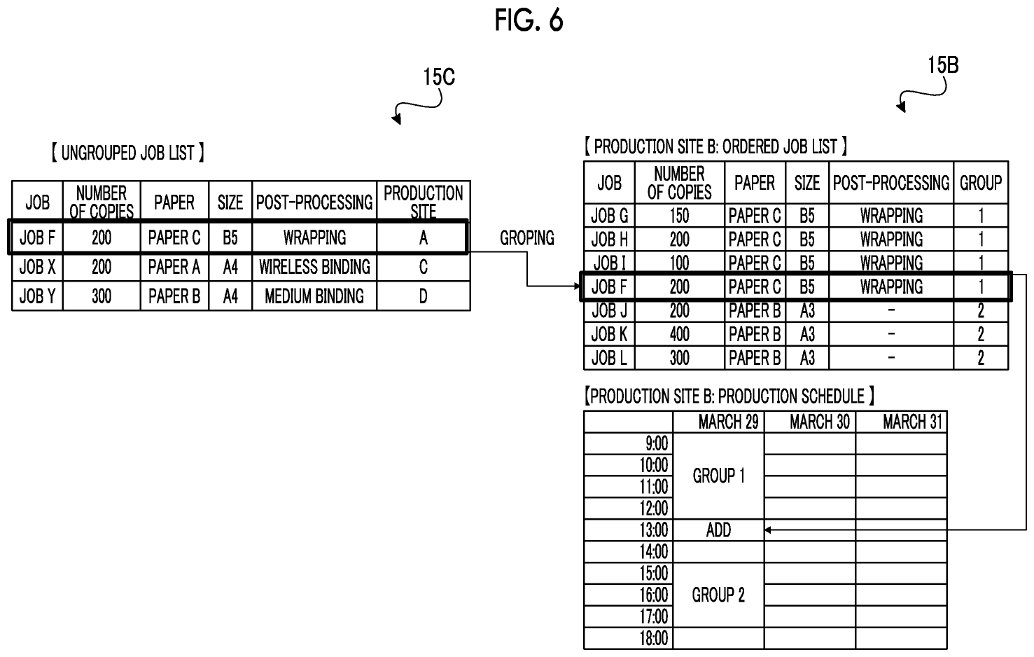

In step S103, the CPU 11 refers to, for example, the production information DB 15B, specifically, the ordered job list and the production schedule of the production site B illustrated in FIG. 5 described above, and determines whether or not there is a groupable site. In a case where it is determined that there is a groupable site (in the case of positive determination), the process proceeds to step S104, and in a case where it is determined that there is no groupable site (in the case of negative determination), the process proceeds to step S107. Here, the grouping availability determination process for ungrouped jobs will be described with reference to FIG. 6.

FIG. 6 is a diagram for explaining a grouping availability determination process for ungrouped jobs according to the exemplary embodiment.

The ungrouped job list illustrated in FIG. 6 is registered in the ungrouped job DB 15C. The ordered job list and the production schedule of the production site B illustrated in FIG. 6 are identical to the example of FIG. 5 described above.

The job F registered in the ungrouped job list illustrated in FIG. 6 is the job specified as the ungrouped job in step S102. In this case, the CPU 11 determines whether or not the job F can be grouped at the production site B. In the example of FIG. 6, in a case of referring to the ordered job list of the production site B, it is known that the attributes of the job F (paper type, paper size, and contents of post-process) are identical to the attributes of each job of the group 1 at the production site B. Further, in a case of referring to the production schedule of the production site B, it can be seen that the time zone (13:00 to 14:00) after the end of the process of the group 1 is free, and the job F can be added, without changing the original production schedules of the group 1 and the group 2. Therefore, it is determined that the job F can be grouped into the group 1 of the production site B.

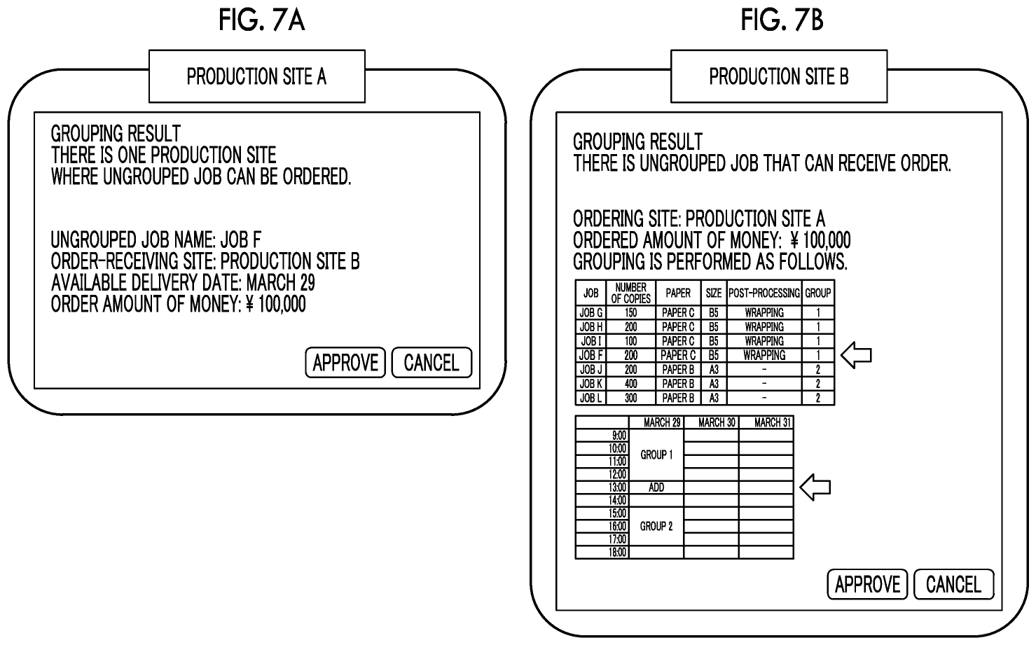

In step S104, the CPU 11 controls the first grouping apparatus 10 to display the ordering screen illustrated in FIG. 7A as an example, and controls the second grouping apparatus 20 to display the order-receiving screen illustrated in FIG. 7B as an example.

FIG. 7A is a front view illustrating an example of the ordering screen according to the present exemplary embodiment. FIG. 7B is a front view illustrating an example of an order-receiving screen according to the exemplary embodiment.

The ordering screen illustrated in FIG. 7A is a screen including the order amount of money in a case of ordering an ungrouped job (for example, job F) , and is an example of the first screen. This ordering screen has an “approve” button for approving the ordering of the ungrouped jobs and a “cancel” button for cancelling the ordering of the ungrouped job. On the other hand, the order-receiving screen illustrated in FIG. 7B is a screen including the ordered amount of money in a case of receiving an order of an ungrouped job (for example, job F) , and is an example of the second screen. This order-receiving screen has an “approve” button for approving the order of the ungrouped job and a “cancel” button for cancelling the order of the ungrouped job. The order amount of money on the ordering screen and the ordered amount of money on the order-receiving screen are appropriately set based on, for example, the amount of ungrouped jobs registered in the ungrouped job DB 15C.

In step S105, the CPU 11 determines whether or not both the ordering side (for example, the production site A) and the order-receiving side (for example, the production site B) have been approved, that is, whether or not both the approval of the ordering of the ungrouped job (for example, the job F) via the ordering screen illustrated in FIG. 7A and the approval of the order-receiving of the ungrouped job (for example, the job F) via the order-receiving screen illustrated in FIG. 7B. More specifically, it is determined whether or not the “approval” button on the ordering screen illustrated in FIG. 7A has been selected and the “approval” button on the order-receiving screen illustrated in FIG. 7B has been selected. In a case where it is determined that both are approved (in the case of positive determination), the process proceeds to step S106, and in a case where it is determined that both are not approved (in the case of negative determination), the process proceeds to step S108.

In step S106, the CPU 11 controls the second grouping apparatus 20 to transmit an ungrouped job (for example, the job F), and ends a series of processes by the first grouping processing program 15A.

On the other hand, in step S107, the CPU 11, for example, displays a message or the like on the display unit 16 of the first grouping apparatus 10 to notify that there is no groupable site, and returns to step S100 to wait until the next grouping.

On the other hand, in step S108, the CPU 11 displays, for example, a message or the like on the display unit 16 of the first grouping apparatus 10, notifies that the grouping is not established, and proceeds to step S109.

In step S109, the CPU 11 sets a deadline for grouping the ungrouped job before the delivery deadline of the ungrouped job (for example, the job F) , and returns to step S100 to wait until the next grouping.

In the case where there are conditions for printing apparatuses and jobs for which grouping is not performed, among production sites, the conditions are set and thus reflected in the grouping process according to the present exemplary embodiment.

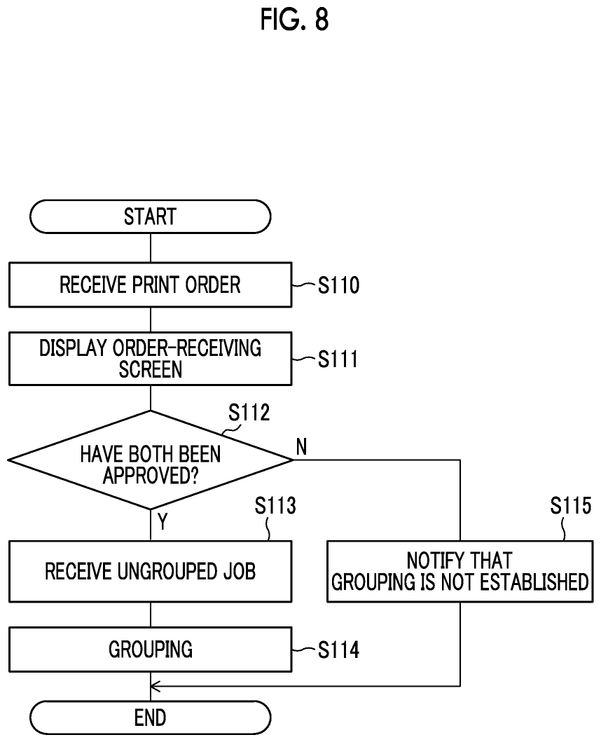

Next, the operation of the second grouping apparatus 20 according to the first exemplary embodiment will be described with reference to FIG. 8.

FIG. 8 is a flowchart illustrating an example of the processing flow by the second grouping processing program 25A according to the first exemplary embodiment.

First, in a case where the user instructs the second grouping apparatus 20 to start the grouping process, the second grouping processing program 25A is activated to execute the following steps.

In step S110 of FIG. 8, the CPU 21 receives a print order for the second printing apparatus 40. A plurality of jobs included in the received print order are grouped and the production schedule of the jobs is created, and as illustrated in FIG. 5, are registered in the production information DB 15B as the ordered job list and production schedule of the production site B.

In step S111, the CPU 21 performs control to display the order-receiving screen illustrated in FIG. 7B, as an example, in response to the instruction to display the order-receiving screen from the first grouping apparatus 10.

In step S112, the CPU 21 determines whether or not both the ordering side (for example, the production site A) and the order-receiving side (for example, the production site B) have been approved. Specifically, it is determined whether or not the “approval” button on the ordering screen illustrated in FIG. 7A described above has been selected and the “approval” button on the order-receiving screen illustrated in FIG. 7B has been selected. In a case where it is determined that both are approved (in the case of positive determination), the process proceeds to step S113, and in a case where it is determined that both are not approved (in the case of negative determination), the process proceeds to step S115.

In step S113, the CPU 21 performs control to receive the ungrouped job (for example, job F) transmitted from the first grouping apparatus 10.

In step S114, as an example, the CPU 21 groups a plurality of jobs (for example, job G to job I) included in the print order received in step S110 and the ungrouped job (for example, job F) received in step S112, and ends a series of processes by the second grouping processing program 25A.

On the other hand, instep S115, the CPU 21, for example, displays a message or the like on the display unit 26 of the second grouping apparatus 20, notifies that the grouping is not established, and ends the series of processes by the second grouping processing program 25A.

As described above, according to the present exemplary embodiment, the grouping apparatus is provided at each production site. In a case where an ungrouped job occurs at a certain production site, the grouping apparatus at the production site plays a central role, and the ungrouped job can be grouped at another production site. Therefore, ungrouped jobs are processed efficiently.

Further, in the job ordering side, it is possible to outsource the job with low profitability at an amount of money lower than usual. On the other hand, on the side of receiving jobs, grouping jobs with identical attribute enables processing without lowering production efficiency, which contributes to improved sales.

### Second Exemplary Embodiment

In the above-described first exemplary embodiment, the aspect in which the grouping apparatus is provided at each production site has been described. In the present exemplary embodiment, an aspect in which a grouping management apparatus that comprehensively manages each production site is provided will be described.

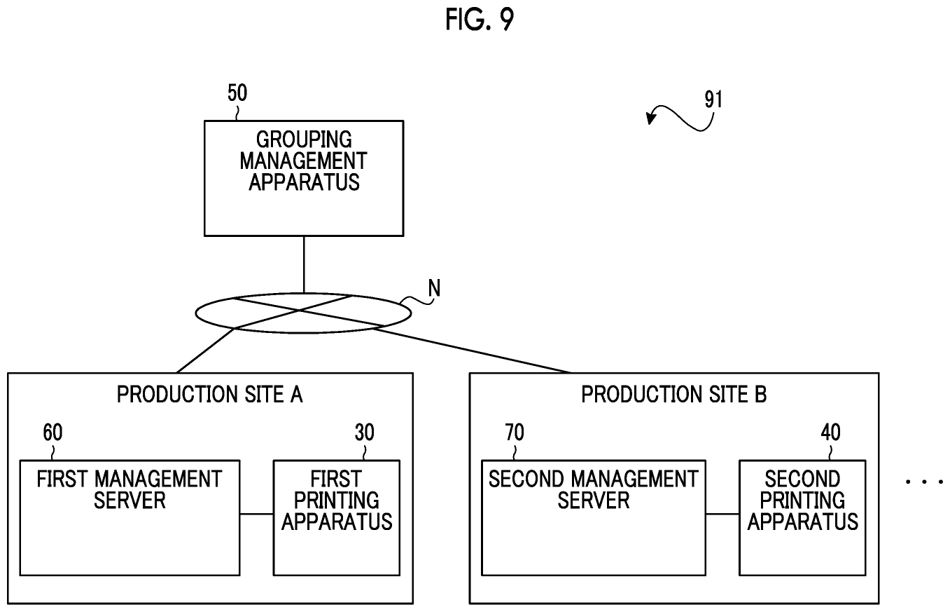

FIG. 9 is a diagram illustrating an example of the configuration of a grouping system 91 according to a second exemplary embodiment.

As illustrated in FIG. 9, the grouping system 91 according to present exemplary embodiment includes a grouping management apparatus 50, a first management server 60, and a second management server 70. The first management server 60 is communicatively connected to the first printing apparatus 30, and the first management server 60 and the first printing apparatus 30 are installed at the production site A. The second management server 70 is communicatively connected to the second printing apparatus 40, and the second management server 70 and the second printing apparatus 40 are installed in the production site B.

The first management server 60 has a function of managing a plurality of jobs processed by the first printing apparatus 30. The first management server 60 and the first printing apparatus 30 may be integrally provided. The second management server 70 has a function of managing a plurality of jobs processed by the second printing apparatus 40. The second management server 70 and the second printing apparatus 40 may be integrally provided.

A general-purpose computer apparatus such as a server computer or a personal computer (PC) is applied to the grouping management apparatus 50. The grouping management apparatus 50 is communicably connected to each of the first management server 60 and the second management server 70 via the network N. The grouping management apparatus 50 has a function of grouping a plurality of jobs processed by the first printing apparatus 30 via the first management server 60 and creating a processing schedule of the plurality of jobs. Further, the grouping management apparatus 50 has a function of grouping a plurality of jobs processed by the second printing apparatus 40 via the second management server 70 and creating a processing schedule of the plurality of jobs.

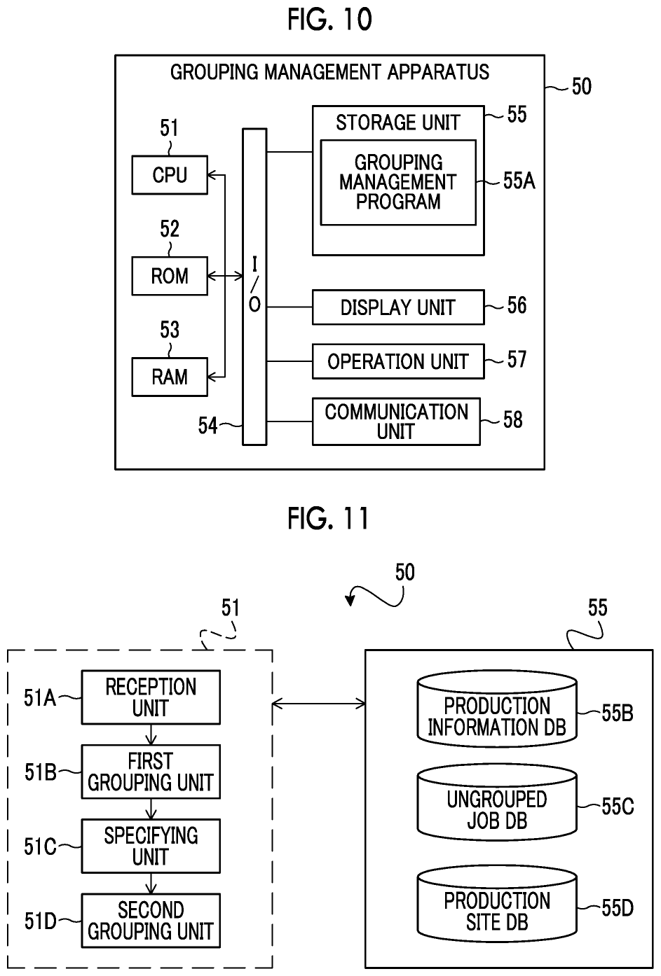

FIG. 10 is a block diagram illustrating an example of the electrical configuration of the grouping management apparatus 50 according to the second exemplary embodiment.

As illustrated in FIG. 10, the grouping management apparatus 50 according to the present exemplary embodiment includes a CPU 51, a ROM 52, a RAM 53, an I/O 54, a storage unit 55, a display unit 56, an operation unit 57, and a communication unit 58.

The CPU 51, the ROM 52, the RAM 53, and the I/O 54 are connected to each other via a bus. Functional units including the storage unit 55, the display unit 56, the operation unit 57, and the communication unit 58 are connected to the I/O 54. Each of these functional units can communicate with the CPU 51 via the I/O 54.

A control unit is configured with the CPU 51, the ROM 52, the RAM 53, and the I/O 54. The control unit may be configured as a sub-control unit that controls a part of the operation of the grouping management apparatus 50, or may be configured as a part of a main control unit that controls the entire operation of the grouping management apparatus 50.

As the storage unit 55, for example, an HDD, an SSD, a flash memory or the like is used. The storage unit 55 stores the grouping management program 55A according to present exemplary embodiment. The grouping management program 55A may be stored in the ROM 52.

The grouping management program 55A may be installed in advance in the grouping management apparatus 50, for example. The grouping management program 55A may be realized by being stored in a non-volatile storage medium or distributed via the network N and appropriately installed in the grouping management apparatus 50.

For the display unit 56, for example, a liquid crystal display (LCD) , an organic EL display or the like is used. The display unit 56 may integrally have a touch panel. The operation unit 57 is provided with a device for operation input such as a keyboard and a mouse. The display unit 56 and the operation unit 57 receive various instructions from the user of the grouping management apparatus 50. The display unit 56 displays various types of information such as a result of a process executed in response to an instruction received from the user and a notification for a process.

The communication unit 58 is connected to a network N such as the Internet, a LAN, and a WAN, and can communicate with each of the first printing apparatus 30 and the second printing apparatus 40 via the network N.

The CPU 51 of the grouping management apparatus 50 according to the present exemplary embodiment functions as each unit illustrated in FIG. 11 by writing the grouping management program 55A stored in the storage unit 55 into the RAM 53 and executing the program 55A. The CPU 51 is an example of a processor.

FIG. 11 is a block diagram illustrating an example of the functional configuration of the grouping management apparatus 50 according to the second exemplary embodiment.

As illustrated in FIG. 11, the CPU 51 of the grouping management apparatus 50 according to the present exemplary embodiment functions as a reception unit 51A, a first grouping unit 51B, a specifying unit 51C, and a second grouping unit 51D.

The storage unit 55 of the grouping management apparatus 50 according to the present exemplary embodiment stores a production information DB 55B, an ungrouped job DB 55C, and a production site DB 55D.

In the production information DB 55B, jobs that have been ordered for each production site constituting the grouping system 91 and a production schedule for processing jobs that have been ordered for each production site are registered. Further, ungrouped jobs that could not be grouped at each production site are registered in the ungrouped job DB 55C. In addition, each production site constituting the grouping system 91 is registered in the production site DB 55D.

The reception unit 51A according to the present exemplary embodiment receives a print order for the first printing apparatus 30 and a print order for the second printing apparatus 40. The reception unit 51A registers each of the plurality of jobs included in the print order for the first printing apparatus 30 in association with the attribute of the job in the production information DB 55B. Similarly, the reception unit 51A registers each of the plurality of jobs included in the print order for the second printing apparatus 40 with the production information DB 55B in association with the attribute thereof. As described above, the job attributes include the number of copies to be printed (the number of printing sheets) , the type of paper, the size of paper, the post-processing content, and the like.

Here, the print order for the first printing apparatus 30 may be received via the first management server 60 installed in the production site A. Similarly, the print order for the second printing apparatus 40 may be received via the second management server 70 installed in the production site B.

The first grouping unit 51B according to the present exemplary embodiment groups a plurality of jobs included in a print order for the first printing apparatus 30. Similarly, the first grouping unit 51B groups a plurality of jobs included in a print order for the second printing apparatus 40. The first management server 60 may perform grouping of a plurality of jobs processed by the first printing apparatus 30, the second management server 70 may perform grouping of a plurality of jobs processed by the second printing apparatus 40, and each grouping result may be acquired. The first grouping unit 51B registers the grouping results of a plurality of jobs at each production site in the production information DB 55B.

The specifying unit 51C according to the present exemplary embodiment specifies an ungrouped job (for example, job F) that could not be grouped by the first grouping unit 51B. The specifying unit 11C registers the job (for example, the job F) specified as the ungrouped job in the ungrouped job DB 55C.

The second grouping unit 51D according to the present exemplary embodiment groups a plurality of jobs (for example, job G to job I) included in the print order for the second printing apparatus 40 and the ungrouped jobs (for example, job F) specified by the specifying unit 51C.

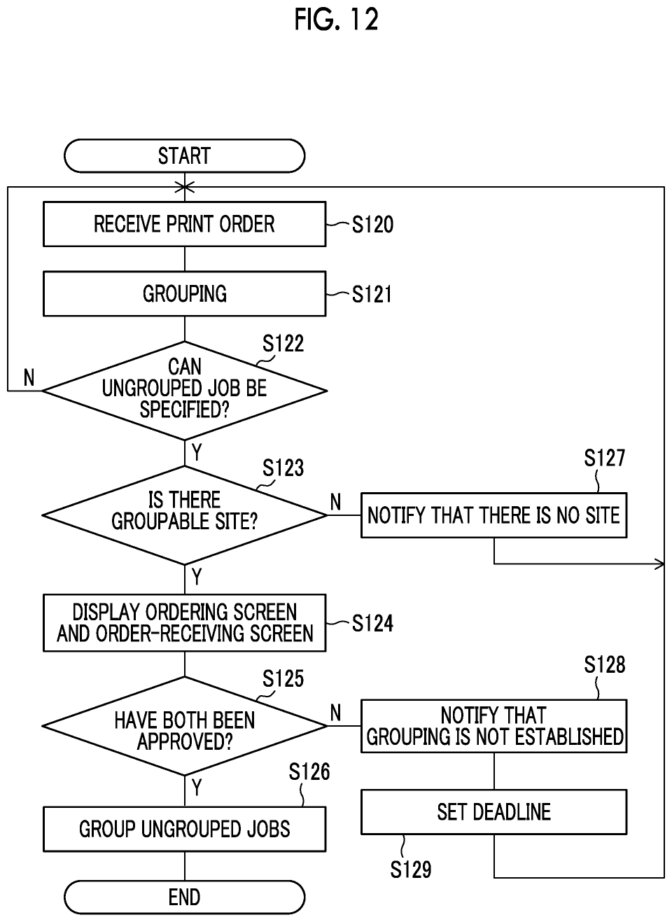

Next, the operation of the grouping management apparatus according to the second exemplary embodiment will be described with reference to FIG. 12.

FIG. 12 is a flowchart illustrating an example of the processing flow by the grouping management program 55A according to the second exemplary embodiment.

First, for example, in a case where an instruction to cause the grouping management apparatus 50 to start the grouping process is issued from the production site A, the grouping management program 55A is activated and the following steps are executed.

In step S120 of FIG. 12, the CPU 51 receives a print order for the first printing apparatus 30 and a print order for the second printing apparatus 40.

In step S121, the CPU 51 groups a plurality of jobs included in the print order for the first printing apparatus 30 received in step S120. Here, the ordered job list and the production schedule of each of the production site A and the production site B are registered in the production information DB 55B as in the example of FIG. 5 described above.

In step S122, the CPU 51 refers to the production information DB 55B, specifically, the ordered job list of the production site A illustrated in FIG. 5 described above, and determines whether or not the ungrouped job can be specified. In a case where it is determined that the ungrouped job can be specified (in the case of positive determination), the process proceeds to step S123, and in a case where it is determined that the ungrouped job cannot be specified (in the case of negative determination), the process returns to step S120 to wait until the next grouping. In the example of FIG. 5 described above, the job F is specified as an ungrouped job. In this case, the CPU 51 registers the job F specified as the ungrouped job in the ungrouped job DB 55C.

In step S123, the CPU 51 refers to the production information DB 55B, specifically, the ordered job list and the production schedule of the production site B illustrated in FIG. 5 described above, as an example, and determines whether or not there is a groupable site. In a case where it is determined that there is a groupable site (in the case of positive determination), the process proceeds to step S124, and in a case where it is determined that there is no groupable site (in the case of negative determination), the process proceeds to step S127. Note that the grouping availability determination process for ungrouped jobs is as described with reference to FIG. 6 described above, and thus the repeated description here is omitted.

In step S124, the CPU 51 controls the first management server 60 to display the ordering screen illustrated in FIG. 7A as an example, and controls the second management server 70 to display the order-receiving screen illustrated in FIG. 7B as an example.

In step S125, the CPU 51 determines whether or not both the ordering side (for example, the production site A) and the order-receiving side (for example, the production site B) have been approved. Specifically, it is determined whether or not the “approval” button on the ordering screen illustrated in FIG. 7A has been selected and the “approval” button on the order-receiving screen illustrated in FIG. 7B has been selected. In a case where it is determined that both are approved (in the case of positive determination), the process proceeds to step S126, and in a case where it is determined that both are not approved (in the case of negative determination), the process proceeds to step S128.

In step S126, the CPU 51 groups the jobs (for example, job G to job I) included in the print order for the second printing apparatus 40 and the ungrouped jobs (for example, job F), and ends a series of processes by the grouping management program 55A.

On the other hand, in step S127, the CPU 51 displays, for example, a message or the like on the first management server 60 to notify that there is no groupable site, and returns to step S120 to wait until the next grouping.

On the other hand, in step S128, the CPU 51 displays a message or the like on the first management server 60 and the second management server 70, notifies that the grouping is not established, and proceeds to step S129.

In step S129, the CPU 51 sets a deadline for grouping the ungrouped job before the delivery deadline of the ungrouped job (for example, the job F) , and returns to step S120 to wait until the next grouping.

As described above, according to present exemplary embodiment, the grouping management apparatus that comprehensively manages each production site is provided. In a case where an ungrouped job occurs at a certain production site, the grouping management apparatus plays a central role, and the ungrouped job can be grouped at another production site. Therefore, ungrouped jobs are processed efficiently.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The grouping system according to the exemplary embodiment has been illustrated and described above. The exemplary embodiment may be in the form of a program for causing a computer to execute the functions of the respective units included in the grouping system. The exemplary embodiment may be in the form of a storage medium readable by a computer that stores the program.

In addition, the configuration of the grouping system described in each of the above exemplary embodiments is merely an example, and may be changed depending on a situation within a scope not deviating from the gist.

Further, the flow of the process of the program described in each of the above exemplary embodiment is also an example, and unnecessary steps may be deleted, new steps may be added, or processing order may be changed within a scope not deviating from the gist.

Further, in the above exemplary embodiments, the case where the process according to the exemplary embodiment is realized by a software configuration using a computer by executing a program has been described, but the present invention is not limited thereto. The exemplary embodiment may be realized by, for example, a hardware configuration or a combination of a hardware configuration and a software configuration.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A grouping system comprising:
a first grouping apparatus having a first processor configured to
receive a print order for a first apparatus, the print order including a plurality of jobs,
group the plurality of jobs included in the print order for the first apparatus,
specify ungrouped jobs that are jobs which are not grouped by the grouping, and
perform a control to transmit the ungrouped jobs to a second grouping apparatus; and
the second grouping apparatus having a second processor configured to
receive a print order for a second apparatus, the print order including jobs,
perform a control to receive the ungrouped jobs from the first grouping apparatus, and
group the jobs included in the print order for the second apparatus and the ungrouped jobs.

2. The grouping system according to claim 1,
wherein the first processor is configured to specify, among the plurality of jobs for the first apparatus, jobs of which attributes do not match, as the ungrouped jobs.

3. The grouping system according to claim 2,
wherein the first processor is configured to perform a control to store the ungrouped job and an amount of money for the ungrouped job in association with each other in a storage unit.

4. The grouping system according to claim 1,
wherein the first processor is configured to perform a control to transmit the ungrouped jobs to the second grouping apparatus, in a case where there is no change in a job processing schedule for the second apparatus due to grouping of the ungrouped jobs by the second grouping apparatus.

5. The grouping system according to claim 2,
wherein the first processor is configured to perform a control to transmit the ungrouped jobs to the second grouping apparatus, in a case where there is no change in a job processing schedule for the second apparatus due to grouping of the ungrouped jobs by the second grouping apparatus.

6. The grouping system according to claim 3,
wherein the first processor is configured to perform a control to transmit the ungrouped jobs to the second grouping apparatus, in a case where there is no change in a job processing schedule for the second apparatus due to grouping of the ungrouped jobs by the second grouping apparatus.

7. The grouping system according to claim 1,
wherein the first processor is configured to perform a control not to transmit the ungrouped jobs to the second grouping apparatus, in a case where there is a change in a job processing schedule for the second apparatus due to grouping of the ungrouped jobs by the second grouping apparatus.

8. The grouping system according to claim 2,
wherein the first processor is configured to perform a control not to transmit the ungrouped jobs to the second grouping apparatus, in a case where there is a change in a job processing schedule for the second apparatus due to grouping of the ungrouped jobs by the second grouping apparatus.

9. The grouping system according to claim 3,
wherein the first processor is configured to perform a control not to transmit the ungrouped jobs to the second grouping apparatus, in a case where there is a change in a job processing schedule for the second apparatus due to grouping of the ungrouped jobs by the second grouping apparatus.

10. The grouping system according to claim 1,
wherein the first processor is configured to inquire whether or not to transmit the ungrouped jobs to the second grouping apparatus, in a case where there is a change in a job processing schedule for the second apparatus due to grouping of the ungrouped jobs by the second grouping apparatus.

11. The grouping system according to claim 2,
wherein the first processor is configured to inquire whether or not to transmit the ungrouped jobs to the second grouping apparatus, in a case where there is a change in a job processing schedule for the second apparatus due to grouping of the ungrouped jobs by the second grouping apparatus.

12. The grouping system according to claim 3,
wherein the first processor is configured to inquire whether or not to transmit the ungrouped jobs to the second grouping apparatus, in a case where there is a change in a job processing schedule for the second apparatus due to grouping of the ungrouped jobs by the second grouping apparatus.

13. The grouping system according to claim 7,
wherein the first processor is configured to set a deadline for grouping the ungrouped jobs before a delivery deadline of the ungrouped jobs, in a case where the ungrouped jobs are not transmitted to the second grouping apparatus.

14. The grouping system according to claim 8,
wherein the first processor is configured to set a deadline for grouping the ungrouped jobs before a delivery deadline of the ungrouped jobs, in a case where the ungrouped jobs are not transmitted to the second grouping apparatus.

15. The grouping system according to claim 1,
wherein the first processor is configured to control the first grouping apparatus to display a first screen including an order amount of money in a case of ordering the ungrouped job, and further control the second grouping apparatus to display a second screen including an ordered amount of money in a case of receiving an order of the ungrouped job.

16. The grouping system according to claim 15,
wherein the first processor is configured to, in a case of receiving both an approval of the ordering of the ungrouped job via the first screen and an approval of the order-receiving of the ungrouped job via the second screen, perform a control to send the ungrouped job to the second grouping apparatus.

17. A first grouping apparatus comprising:
a first processor configured to
receive a print order for a first apparatus, the print order including a plurality of jobs,
group the plurality of jobs included in the print order for the first apparatus,
specify ungrouped jobs that are jobs which are not grouped by the grouping, and
perform a control to transmit the ungrouped jobs to the second grouping apparatus.

18. A second grouping apparatus comprising:
a second processor configured to
receive a print order for a second apparatus, the print order including jobs,
perform a control to receive the ungrouped jobs from the first grouping apparatus according to claim 10, and
group the jobs included in the print order for the second apparatus and the ungrouped jobs.

19. A grouping management apparatus comprising:
a processor configured to
receive a print order for a first apparatus, the print order including a plurality of jobs,
receive a print order for a second apparatus, the print order including jobs,
group the plurality of jobs included in the print order for the first apparatus,
specify ungrouped jobs that are jobs which are not grouped by the grouping, and
group the jobs included in the print order for the second apparatus and the ungrouped jobs.

20. A non-transitory computer readable medium storing
a grouping management program causing a computer to execute a process, the process comprising:
receiving a print order for a first apparatus, the print order including a plurality of jobs,
receiving a print order for a second apparatus, the print order including jobs,
grouping the plurality of jobs included in the print order for the first apparatus,
specifying ungrouped jobs that are jobs which are not grouped by the grouping, and
grouping the jobs included in the print order for the second apparatus and the ungrouped jobs.
